(19) United States
(12) Patent Application Publication
(10) Pub. No.: US 2017/0194782 A1
(43) Pub. Date: Jul. 6, 2017

(54) Process For Assembling An Electric Transmission Cable To An Accessory

(71) Applicant: NEXANS, PARIS (FR)

(72) Inventor: Pierre MIREBEAU, VILLEBON SUR YVETTE (FR)

(21) Appl. No.: 15/312,996

(22) PCT Filed: Apr. 22, 2015
(86) PCT No.: PCT/FR2015/051091

§ 371 Date: Nov. 21, 2016

(30) Foreign Application Priority Data
May 19, 2014 (FR) 14 54440

(51) Int. Cl. H02G 15/02; H02G 1/14

(52) U.S. Cl. CPC H02G 15/02; H02G 1/14

(57) ABSTRACT

The invention relates to a process for assembling an electric transmission cable to an accessory by threading of the cable, the outer surface of which is constituted of the outer surface of its insulating layer surrounding a conductor, into a bore of the accessory, with the aid of a slip agent comprising silicone oil.

According to the invention, said slip agent also comprises a polar aprotic solvent forming an interface fluid between said electric transmission cable and said accessory.

The invention relates to a process for assembling an electric transmission cable to an accessory, such as a joint or a termination, by threading of the cable, in particular DC high-voltage cable.

During the assembling of a high-voltage electric cable to an accessory, this cable, the outer surface of which is constituted by the outer surface of its insulating layer surrounding the conductor with insertion of a semi-conducting layer, may have to be threaded into a bore of the accessory, with a particularly reduced clearance between the outer diameter of the cable and the inner diameter of the bore.

It is conventional to use silicone oil as a slip agent positioned on the outer surface of the cable to facilitate this assembly.

This being said, once the cable and accessory are assembled, a relatively large amount of oil remains at their interface between the insulating material of the cable and the semi-conducting material or the insulating material of the accessory. This results in a very disturbed transmission of space charges, in operation, the oil having a relatively low dielectric constant, and consequently in frequent electrical breakdowns.

The invention resolves this problem by proposing to partially replace this silicone oil with a polar aprotic solvent and therefore proposes the use of a polar aprotic solvent as interface fluid between an electric transmission cable and an accessory.

The dielectric constant of a polar aprotic solvent is much higher than 7, which is favorable to the solvation and to the transmission of the space charges between the cable and the accessory when assembled and in operation.

A polar aprotic solvent is a solvent having a dipole moment, but no acidic hydrogen unlike protic solvents.

An example of a polar aprotic solvent is DMSO (dimethyl sulfoxide: (CH₃)₂S═O) which is a polar aprotic solvent since the formation of its conjugated base —CH₂S(O)CH₃ necessitates breaking a C—H bond.

The invention relates to a process for assembling an electric transmission cable to an accessory by threading of the cable, the outer surface of which is constituted of the outer surface of its insulating layer surrounding a conductor, into a bore of the accessory, with the aid of a slip agent comprising silicone, wherein said slip agent also comprises a polar aprotic solvent forming an interface fluid between said electric transmission cable and said accessory.

Even though the slick property of a polar aprotic solvent is lower than that of a silicone oil, a good compromise is thus found between slip property intended to enable the threading and dielectric constant.

According to one preferred embodiment, said polar aprotic solvent is a cyclic alkylene carbonate. The cyclic alkylene carbonate is a carbonate ester of formula:

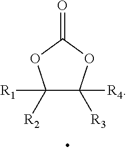

This solvent has the advantage of not being dangerous for the environment and human health.

By way of example, the solvent known as “PROPYLENE CARBONATE” sold by Merck Chemicals under the reference 807051 may be used.

The solvent may also be acetonitrile or dialkyl carbonate, for example.

The content of said polar aprotic solvent in said slip agent is greater than or equal to 30% by volume, and preferably substantially equal to 70% by volume.

The invention finally relates to an electrical accessory equipped with an electric transmission cable, by means of such an assembly process, the interface between accessory and cable comprising said polar aprotic solvent and silicone oil.

Preferably, said cable is a DC high-voltage cable.

1. A process for assembling an electric transmission cable to an accessory by threading of the cable, the outer surface of which is made of the outer surface of its insulating layer surrounding a conductor, into a bore of the accessory, with the aid of a slip agent that includes silicone oil, wherein said slip agent also has a polar aprotic solvent forming an interface fluid between said electric transmission cable and said accessory.

2. The process as claimed in claim 1, wherein said polar aprotic solvent is cyclic alkylene carbonate.

3. The process as claimed in claim 1, wherein said polar aprotic solvent is acetonitrile.

4. The process as claimed in claim 1, wherein the content of said polar aprotic solvent in said slip agent is greater than or equal to 30% by volume.

5. The process as claimed in claim 4, wherein the content of said polar aprotic solvent is substantially equal to 70% by volume.

6. An electrical accessory equipped with an electric transmission cable, by means of the assembly process as claimed in claim 1, wherein the interface between accessory and cable comprises said polar aprotic solvent and silicone oil.

7. The accessory as claimed in claim 6, wherein said cable is a DC high-voltage cable.
